(19) United States
(12) Patent Application Publication
(10) Pub. No.: US 2009/0271172 A1
(43) Pub. Date: Oct. 29, 2009

(54) Emulating A Computer Run Time Environment

(75) Inventors: Eric O. Mejdrich, Rochester, MN (US); Paul E. Schardt, Rochester, MN (US); Corey V. Swenson, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/108,770

(22) Filed: Apr. 24, 2008

(51) Int. Cl. G06F 9/455

(52) U.S. Cl. 703/26

(57) ABSTRACT

Emulating a computer run time environment as a component of a dynamic binary translation loop that translates target executable code compiled for execution on a target computer to code executable on a host computer of a kind other than the target computer, the target executable code including function calls to functions to be translated. Embodiments of the present invention include: determining, upon encountering in the binary translation loop a function call to a function to be translated, that the function call is a call to a host library function in a host native library; hashing a target executable image of the function to be translated from the target executable code, thereby producing a hash value; and using the hash value as an index to retrieve from a thunk table a host native address of the host library function in the host native library.

### BACKGROUND OF THE INVENTION

1. Field of the Invention

The field of the invention is data processing, or, more specifically methods, apparatus, and products for emulating a computer run time environment.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer systems advance, software designed to run on older computer systems is increasingly more difficult and sometimes impossible to execute natively on the more advanced computer systems. One way to execute computer software on a computer system for which the computer software was not intended to run is to emulate, that is, imitate, the computer system for which the computer software was intended to run on the computer system for which the computer software was not indented to run. Current methods of emulating computer systems, however, are often inefficient.

### SUMMARY OF THE INVENTION

Methods, apparatus, and products for emulating a computer run time environment are disclosed that include, a dynamic binary translation loop that translates target executable code compiled for execution on a target computer to code executable on a host computer of a kind other than the target computer, the target executable code including function calls to functions to be translated. Embodiments of the present invention include: determining, upon encountering in the binary translation loop a function call to a function to be translated, that the function call is a call to a host library function in a host native library; hashing a target executable image of the function to be translated from the target executable code, thereby producing a hash value; and using the hash value as an index to retrieve from a thunk table a host native address of the host library function in the host native library.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary computing environment useful for emulating a computer run time environment according to embodiments of the present invention.

FIG. 2 sets forth a block diagram of automated computing machinery comprising an exemplary computer useful in emulating a computer run time environment according to embodiments of the present invention.

FIG. 3 sets forth a functional block diagram of an example apparatus useful for emulating a computer run time environment according to embodiments of the present invention.

FIG. 4 sets forth a functional block diagram of a further example apparatus useful for emulating a computer run time environment according to embodiments of the present invention.

FIG. 5 sets forth a flow chart illustrating an exemplary method for data processing with an apparatus useful for emulating a computer run time environment according to embodiments of the present invention.

FIG. 6 sets forth a flow chart illustrating an exemplary method for emulating a computer run time environment according to embodiments of the present invention.

FIG. 7 sets forth a flow chart illustrating a further exemplary method for emulating a computer run time environment according to embodiments of the present invention.

FIG. 8 sets forth a flow chart illustrating a further exemplary method for emulating a computer run time environment according to embodiments of the present invention.

### DETAILED DESCRIPTION OF EXEMPLARY EMBODIMENTS

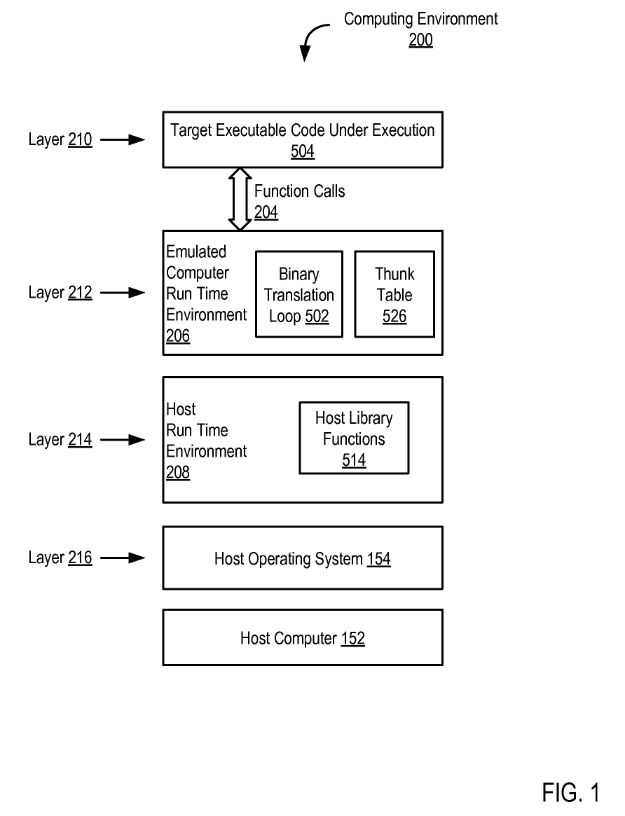

Exemplary methods, apparatus, and products for emulating a computer run time environment in accordance with the present invention are described with reference to the accompanying drawings, beginning with FIG. 1. FIG. 1 sets forth a block diagram of an exemplary computing environment useful for emulating a computer run time environment according to embodiments of the present invention. Emulation as the term is used in this specification refers to the imitation of one computer, the target computer, by another computer, the host computer. The term ‘target’ as used in this specification refers to a subject of emulation, while the term ‘host’ refers to a computing environment in which emulation is carried out. A target computer, target executable code, target run time environments, target operating systems, and so on, for example, may be emulated on a host computer running a host operating system and a host run time environment.

The exemplary computer environment (200) of FIG. 1 includes four layers of software, modules of computer program instructions, running on a host computer (152), automated computing machinery. The lowest layer (216) of software depicted in the exemplary computing environment (200) of FIG. 1 is a host operating system (154). Examples of host operating systems in computing environments (200) useful emulating a computer run time environment according to embodiments of the present invention include UNIX™, Linux™, Microsoft XP™, AIX™, IBM's i5/OS™, and others as will occur to those of skill in the art.

Operating at a layer (214) above the host operating system (154), in the exemplary computing environment (200) of FIG. 1, is a host run time environment (208). A run time environment is a virtual machine state which provides software services for processes or programs while a computer is running. The host run time environment (208) in the example of FIG. 1 includes host library functions (514). A host library functions may be a module of computer program instructions that performs a specific task such as, for example, providing system services to a native host application. Native host applications operating at layers above the host run time environment may call host library functions to perform such specific tasks.

Operating at a layer above the exemplary host run time environment (208) of FIG. 1 is an emulated computer run time environment (206) for a target computer. Such an emulated computer run time environment (206) for a target computer is a run time environment for software originally intended to be executed upon a target computer. By analogy, an emulated computer run time environment is to target software what a host run time environment is to host software.

The exemplary emulated computer run time environment (206) of FIG. 1 includes a binary translation loop (502). Binary translation is the emulation of one instruction set by another through translation of code. In binary translation, computer program instructions are translated from a target instruction set to a host instruction set. There are two types of binary translation, static and dynamic. In static binary translation, an entire executable file is translated prior to execution of the file into an executable file of the host architecture. In dynamic translation, by contrast, code is translated as it discovered during execution of the code in an emulated computer run time environment. Dynamic translation typically includes translating a short sequence of code such as, for example, a single basic block, and caching the resulting translated sequence for execution in the emulated computer run time environment. A basic block of code may be a sequence of instructions with a single entry point, single exit point, and no internal branches.

The exemplary dynamic binary translation loop (502) of FIG. 1 is a module of computer program instructions that translates target executable code (504) compiled for execution on a target computer to code executable on a host computer (152) of a kind other than the target computer. Such target executable code (504) is depicted in the example of FIG. 1 as executing at a layer (210) above the emulated computer run time environment (206).

The binary translation loop operates generally for emulating a computer run time environment in accordance with embodiments of the present invention. During execution, and translation, of the target executable code (504), the binary translation loop (502) may encounter one or more function calls (204) to functions to be translated. Upon encountering such a function call (204) to a function to be translated, the binary translation loop may emulate a computer run time environment in accordance with embodiments of the present invention by: determining that the function call (508) is a call to a host library function (514) in a host native library; hashing a target executable image of the function to be translated from the target executable code (504), thereby producing a hash value; and using the hash value as an index to retrieve from a thunk table (526) a host native address of the host library function (514) in the host native library.

The term ‘thunk’ typically refers to a process of mapping machine data from one system-specific form to another, usually for compatibility reasons. Running a 16-bit program on a 32-bit operating system, for example, may require a so-called ‘thunk’ from 16-bit addresses to 32-bit addresses. The term ‘thunk’ in this sense may also refer to mappings from one calling convention to another or from one version of a library to another. A thunk table (526) as used in this specification is a data structure useful for storing associations of data from one computer system-specific form, the target computer form, with data from another computer-system specific form, the host computer form. Specifically the thunk table (526) in FIG. 1 is an example of a data structure that associates target data forms and host data forms as a column of hash values of function calls of target executable code and a column of host native addresses of host library functions of a host computer, so that each record in the exemplary thunk table (526) of FIG. 1 associates a hash value of a function to be translated and a host native address of a corresponding host library function.

The binary translation loop (502), after retrieving the host native address from the thunk table (526), may return the host native address of the host library function (514) to the emulated computer run time environment (206) of the target computer. The emulated computer run time environment (206) may call the host library function (514) at the host native address and administer any return value or values that may be produced by the execution of the host library function (514).

As an alternative to returning, by the binary translation loop (502) to the emulated computer run time environment (208) of the target computer, only the host native address of the host library function (514), the binary translation loop (502) may return to the emulated computer run time environment (206) an entire executable image of the host library function (514). From the perspective of the emulated computer run time environment, such a return of an entire executable image of the host library function (514) would appear no different than an actual translation of the target function. The emulated computer run time environment may execute the executable image of the host library function and administer any return value or values that may be produced by the execution of the host library function (514).

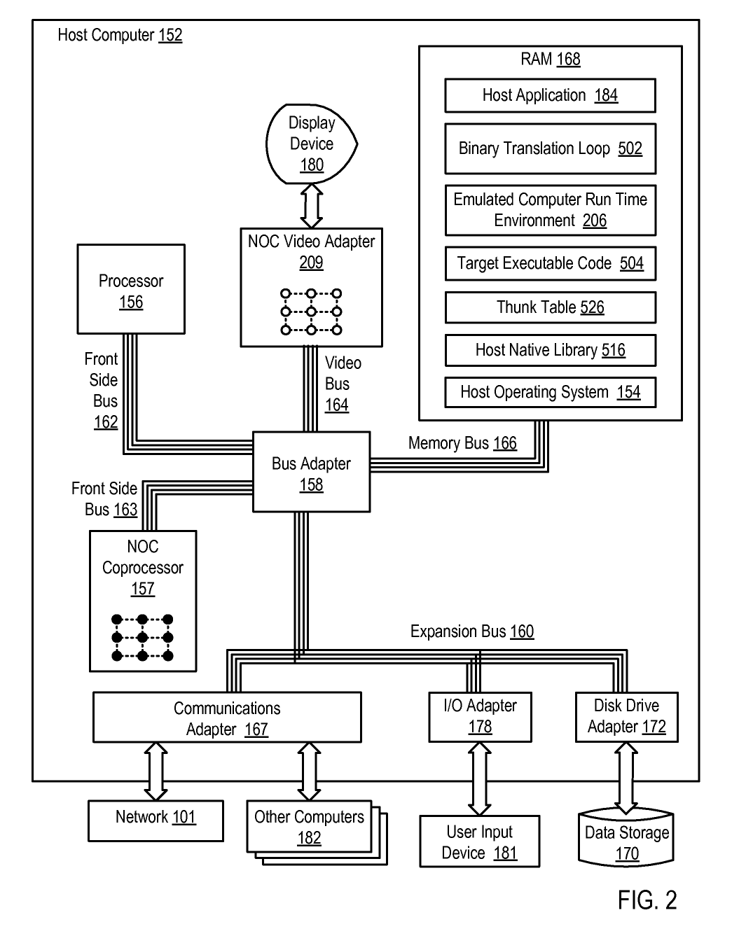

Emulating a computer run time environment in accordance with the present invention is generally implemented with computers, that is, with automated computing machinery, such as the exemplary host computer (152) of FIG. 1. For further explanation, therefore FIG. 2 sets forth a block diagram of automated computing machinery comprising an exemplary host computer (152) useful in emulating a computer run time environment according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a host application program (184), a module of user-level computer program instructions, compiled for execution on a host computer, where the computer program instructions are useful for carrying out particular data processing tasks such as, for example, word processing, spreadsheets, database operations, video gaming, stock market simulations, atomic quantum process simulations, or other user-level applications.

Also stored in RAM is target executable code (504). The target executable code includes function calls to functions to be translated by a binary translation loop (502) which is also stored in RAM (168). The binary translation loop (502) in the example of FIG. 2 is a module of computer program instructions that translates target executable code (504) compiled for execution on a target computer to code executable on a host computer (152) of a kind other than the target computer. The exemplary binary translation loop (502) translates such target executable code thereby providing emulation of a computer run time environment according to embodiments of the present invention by: determining, upon encountering a function call to a function to be translated, that the function call is a call to a host library function in a host native library (516); hashing a target executable image of the function to be translated from the target executable code (504), thereby producing a hash value; and using the hash value as an index to retrieve from a thunk table (526) a host native address of the host library function in the host native library (516).

Emulating a computer run time environment in accordance with embodiments of the present invention may implemented by a computer processor (156) by executing computer program instructions of the exemplary binary translation loop (502). Readers of skill in the art will immediately recognize, however, that emulating a computer run time environment in accordance with embodiments of the present invention may also be implemented by, or even on, the exemplary NOC coprocessor (157).

Also stored in RAM (168) is an operating system (154). Operating systems useful emulating a computer run time environment according to embodiments of the present invention include UNIX™, Linux™, Microsoft XP™, AIX™, IBM's i5/OS™, and others as will occur to those of skill in the art. The operating system (154) and the application (184) in the example of FIG. 2 are shown in RAM (168), but many components of such software typically are stored in non-volatile memory also, such as, for example, on a disk drive (170).

The example computer (152) includes two example NOCs according to embodiments of the present invention: a video adapter (209) and a coprocessor (157). The video adapter (209) is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example NOC coprocessor (157) is connected to processor (156) through bus adapter (158), and front side buses (162 and 163), which is also a high speed bus. The NOC coprocessor of FIG. 2 is optimized to accelerate particular data processing tasks at the behest of the main processor (156).

The example NOC video adapter (209) and NOC coprocessor (157) of FIG. 2 each include a NOC, including integrated processor (‘IP’) blocks, routers, memory communications controllers, and network interface controllers, each IP block adapted to a router through a memory communications controller and a network interface controller, each memory communications controller controlling communication between an IP block and memory, and each network interface controller controlling inter-IP block communications through routers. The NOC video adapter and the NOC coprocessor are optimized for programs that use parallel processing and also require fast random access to shared memory. The details of the NOC structure and operation are discussed below with reference to FIGS. 2-4.

The computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for emulating a computer run time environment according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for emulating a computer run time environment according to embodiments of the present invention include modems for wired dial-up communications, Ethernet (IEEE 802.3) adapters for wired data communications network communications, and 802.11 adapters for wireless data communications network communications.

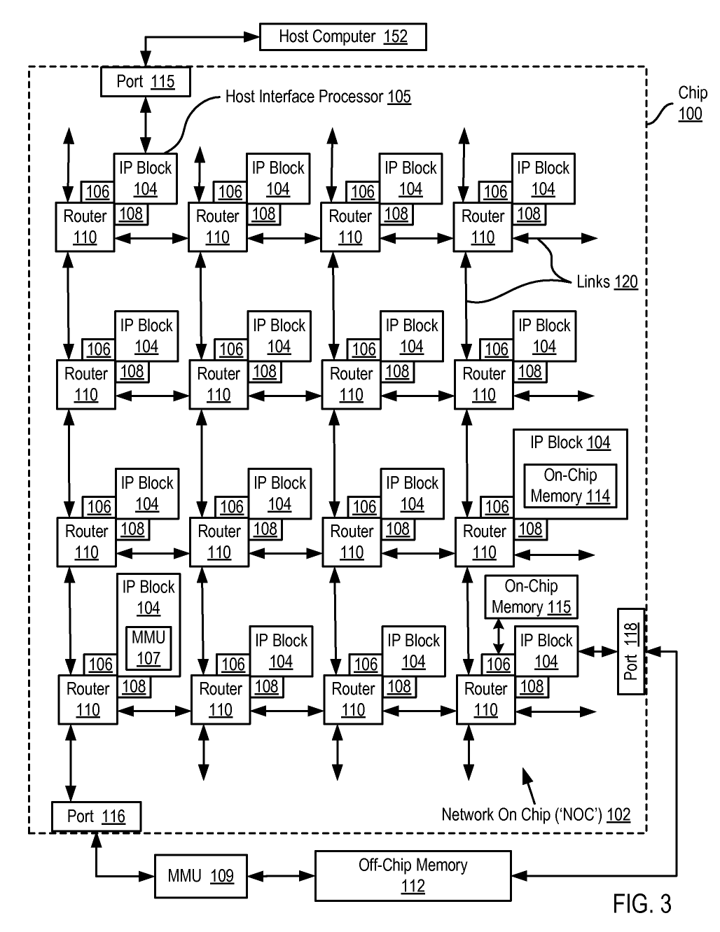

For further explanation, FIG. 3 sets forth a functional block diagram of an example apparatus useful for emulating a computer run time environment according to embodiments of the present invention, a NOC (102). The NOC in the example of FIG. 3 is implemented on a ‘chip’ (100), that is, on an integrated circuit. The NOC (102) of FIG. 3 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110).

In the NOC (102) of FIG. 3, each IP block represents a reusable unit of synchronous or asynchronous logic design used as a building block for data processing within the NOC. The term ‘IP block’ is sometimes expanded as ‘intellectual property block,’ effectively designating an IP block as a design that is owned by a party, that is the intellectual property of a party, to be licensed to other users or designers of semiconductor circuits. In the scope of the present invention, however, there is no requirement that IP blocks be subject to any particular ownership, so the term is always expanded in this specification as ‘integrated processor block.’ IP blocks, as specified here, are reusable units of logic, cell, or chip layout design that may or may not be the subject of intellectual property. IP blocks are logic cores that can be formed as ASIC chip designs or FPGA logic designs.

One way to describe IP blocks by analogy is that IP blocks are for NOC design what a library is for computer programming or a discrete integrated circuit component is for printed circuit board design. In NOCs, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHDL. In addition to netlist and synthesizable implementation, NOCs also may be delivered in lower-level, physical descriptions. Analog IP block elements such as SERDES, PLL, DAC, ADC, and so on, may be distributed in a transistor-layout format such as GDSII. Digital elements of IP blocks are sometimes offered in layout format as well.

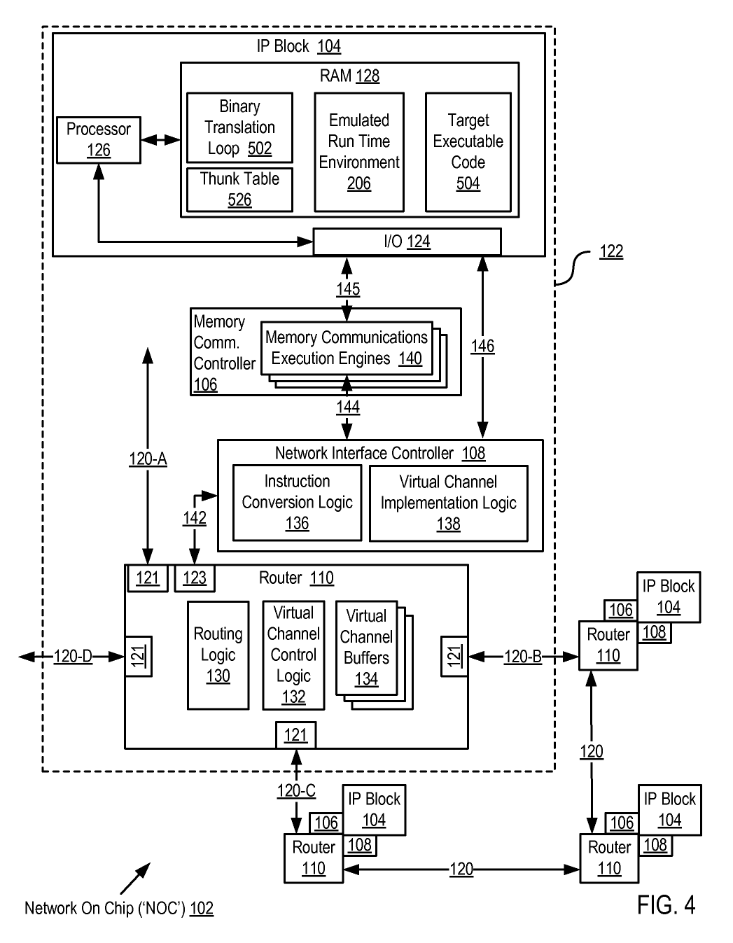

Each IP block (104) in the example of FIG. 3 is adapted to a router (110) through a memory communications controller (106). Each memory communication controller is an aggregation of synchronous and asynchronous logic circuitry adapted to provide data communications between an IP block and memory. Examples of such communications between IP blocks and memory include memory load instructions and memory store instructions. The memory communications controllers (106) are described in more detail below with reference to FIG. 4.

Each IP block (104) in the example of FIG. 3 is also adapted to a router (110) through a network interface controller (108). Each network interface controller (108) controls communications through routers (110) between IP blocks (104). Examples of communications between IP blocks include messages carrying data and instructions for processing the data among IP blocks in parallel applications and in pipelined applications. The network interface controllers (108) are described in more detail below with reference to FIG. 4.

Each IP block (104) in the example of FIG. 3 is adapted to a router (110). The routers (110) and links (120) among the routers implement the network operations of the NOC. The links (120) are packets structures implemented on physical, parallel wire buses connecting all the routers. That is, each link is implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wise, 512 wires. In addition, each link is bi-directional, so that if the link packet structure includes 64 bytes, the wire bus actually contains 1024 wires between each router and each of its neighbors in the network. A message can includes more than one packet, but each packet fits precisely onto the width of the wire bus. If the connection between the router and each section of wire bus is referred to as a port, then each router includes five ports, one for each of four directions of data transmission on the network and a fifth port for adapting the router to a particular IP block through a memory communications controller and a network interface controller.

Each memory communications controller (106) in the example of FIG. 3 controls communications between an IP block and memory. Memory can include off-chip main RAM (112), memory (115) connected directly to an IP block through a memory communications controller (106), on-chip memory enabled as an IP block (114), and on-chip caches. In the NOC of FIG. 3, either of the on-chip memories (114, 115), for example, may be implemented as on-chip cache memory. All these forms of memory can be disposed in the same address space, physical addresses or virtual addresses, true even for the memory attached directly to an IP block. Memory addressed messages therefore can be entirely bidirectional with respect to IP blocks, because such memory can be addressed directly from any IP block anywhere on the network. Memory (114) on an IP block can be addressed from that IP block or from any other IP block in the NOC. Memory (115) attached directly to a memory communication controller can be addressed by the IP block that is adapted to the network by that memory communication controller—and can also be addressed from any other IP block anywhere in the NOC.

As mentioned above, emulating a computer run time environment in accordance with embodiments of the present invention may be implemented by or on a NOC. Any of the on-chip memory (114,115) or off-chip memory (112) of the exemplary NOC (102) in FIG. 2 may, for example, include target executable code, which in turn includes function calls to a function to be translated by a binary translation loop. Such a binary translation loop may also be stored in on-chip memory (114,115) or off-chip memory (112) of the NOC. Such a binary translation loop is a module of computer program instructions that translates target executable code compiled for execution on a target computer to code executable on a host computer of a kind other than the target computer. Any IP block (104) in the example of FIG. 2 having a generally programmable computer processor may execute computer program instructions of such a binary loop and, in doing so, the binary translation loop may translate target executable code thereby providing emulation of a computer run time environment in accordance with embodiments of the present invention by: determining, upon encountering a function call to a function to be translated, that the function call is a call to a host library function in a host native library; hashing a target executable image of the function to be translated from the target executable code, thereby producing a hash value; and using the hash value as an index to retrieve from a thunk table a host native address of the host library function in the host native library.

The example NOC also includes two memory management units (‘MMUs’) (107, 109), illustrating two alternative memory architectures for NOCs. MMU (107) is implemented with an IP block, allowing a processor within the IP block to operate in virtual memory while allowing the entire remaining architecture of the NOC to operate in a physical memory address space. The MMU (109) is implemented off-chip, connected to the NOC through a data communications port (116). The port (116) includes the pins and other interconnections required to conduct signals between the NOC and the MMU, as well as sufficient intelligence to convert message packets from the NOC packet format to the bus format required by the external MMU (109). The external location of the MMU means that all processors in all IP blocks of the NOC can operate in virtual memory address space, with all conversions to physical addresses of the off-chip memory handled by the off-chip MMU (109).

In addition to the two memory architectures illustrated by use of the MMUs (107, 109), data communications port (118) illustrates a third memory architecture useful in NOCs. Port (118) provides a direct connection between an IP block (104) of the NOC (102) and off-chip memory (112). With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port (118). The port (118) includes the pins and other interconnections required to conduct signals between the NOC and the off-chip memory (112), as well as sufficient intelligence to convert message packets from the NOC packet format to the bus format required by the off-chip memory (112).

In the example of FIG. 3, one of the IP blocks is designated a host interface processor (105). A host interface processor (105) provides an interface between the NOC and a host computer (152) in which the NOC may be installed and also provides data processing services to the other IP blocks on the NOC, including, for example, receiving and dispatching among the IP blocks of the NOC data processing requests from the host computer. A NOC may, for example, implement a video graphics adapter (209) or a coprocessor (157) on a larger computer (152) as described above with reference to FIG. 2. In the example of FIG. 3, the host interface processor (105) is connected to the larger host computer through a data communications port (115). The port (115) includes the pins and other interconnections required to conduct signals between the NOC and the host computer, as well as sufficient intelligence to convert message packets from the NOC to the bus format required by the host computer (152). In the example of the NOC coprocessor in the computer of FIG. 2, such a port would provide data communications format translation between the link structure of the NOC coprocessor (157) and the protocol required for the front side bus (163) between the NOC coprocessor (157) and the bus adapter (158).

For further explanation, FIG. 4 sets forth a functional block diagram of a further example apparatus useful for emulating a computer run time environment according to embodiments of the present invention, another example NOC. The example NOC of FIG. 4 is similar to the example NOC of FIG. 3 in that the example NOC of FIG. 4 is implemented on a chip (100 on FIG. 3), and the NOC (102) of FIG. 4 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110). In the example of FIG. 4, one set (122) of an IP block (104) adapted to a router (110) through a memory communications controller (106) and network interface controller (108) is expanded to aid a more detailed explanation of their structure and operations. All the IP blocks, memory communications controllers, network interface controllers, and routers in the example of FIG. 4 are configured in the same manner as the expanded set (122).

In the example of FIG. 4, each IP block (104) includes a computer processor (126) and I/O functionality (124). In this example, computer memory is represented by a segment of random access memory (‘RAM’) (128) in each IP block (104). The memory, as described above with reference to the example of FIG. 3, can occupy segments of a physical address space whose contents on each IP block are addressable and accessible from any IP block in the NOC. The processors (126), I/O capabilities (124), and memory (128) on each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention.

As mentioned above, emulating a computer run time environment (206) in accordance with embodiments of the present invention may be implemented on a NOC (102). In fact, emulating a computer run time environment (206) according to embodiments of the present invention may be implemented on a single IP block (104) of a NOC (102). Consider, for example, IP block (104) of the expanded set (122) which includes a computer processor (126) and RAM (128). Stored in RAM (128) is target executable code (504). The target executable code includes function calls to functions to be translated by a binary translation loop (502) which is also stored in RAM (128). The binary translation loop (502) in the example of FIG. 4 is a module of computer program instructions that translates target executable code (504) compiled for execution on a target computer to code executable on a host computer (152) of a kind other than the target computer. The exemplary binary translation loop (502) translates such target executable code in accordance with embodiments of the present invention by: determining, upon encountering a function call to a function to be translated, that the function call is a call to a host library function in a host native library (516); hashing a target executable image of the function to be translated from the target executable code (504), thereby producing a hash value; and using the hash value as an index to retrieve from a thunk table (526) a host native address of the host library function in the host native library (516).

In the NOC (102) of FIG. 4, each memory communications controller (106) includes a plurality of memory communications execution engines (140). Each memory communications execution engine (140) is enabled to execute memory communications instructions from an IP block (104), including bidirectional memory communications instruction flow (142, 144, 145) between the network and the IP block (104). The memory communications instructions executed by the memory communications controller may originate, not only from the IP block adapted to a router through a particular memory communications controller, but also from any IP block (104) anywhere in the NOC (102). That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions.

Each memory communications execution engine (140) is enabled to execute a complete memory communications instruction separately and in parallel with other memory communications execution engines. The memory communications execution engines implement a scalable memory transaction processor optimized for concurrent throughput of memory communications instructions. The memory communications controller (106) supports multiple memory communications execution engines (140) all of which run concurrently for simultaneous execution of multiple memory communications instructions. A new memory communications instruction is allocated by the memory communications controller (106) to a memory communications engine (140) and the memory communications execution engines (140) can accept multiple response events simultaneously. In this example, all of the memory communications execution engines (140) are identical. Scaling the number of memory communications instructions that can be handled simultaneously by a memory communications controller (106), therefore, is implemented by scaling the number of memory communications execution engines (140).

In the NOC (102) of FIG. 4, each network interface controller (108) is enabled to convert communications instructions from command format to network packet format for transmission among the IP blocks (104) through routers (110). The communications instructions are formulated in command format by the IP block (104) or by the memory communications controller (106) and provided to the network interface controller (108) in command format. The command format is a native format that conforms to architectural register files of the IP block (104) and the memory communications controller (106). The network packet format is the format required for transmission through routers (110) of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In the NOC (102) of FIG. 4, each IP block is enabled to send memory-address-based communications to and from memory through the IP block's memory communications controller and then also through its network interface controller to the network. A memory-address-based communications is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller to an associated network interface controller for conversion (136) from command format to packet format and transmission through the network in a message. In converting to packet format, the network interface controller also identifies a network address for the packet in dependence upon the memory address or addresses to be accessed by a memory-address-based communication. Memory address based messages are addressed with memory addresses. Each memory address is mapped by the network interface controllers to a network address, typically the network location of a memory communications controller responsible for some range of physical memory addresses. The network location of a memory communication controller (106) is naturally also the network location of that memory communication controller's associated router (110), network interface controller (108), and IP block (104). The instruction conversion logic (136) within each network interface controller is capable of converting memory addresses to network addresses for purposes of transmitting memory-address-based communications through routers of a NOC.

Upon receiving message traffic from routers (110) of the network, each network interface controller (108) inspects each packet for memory instructions. Each packet containing a memory instruction is handed to the memory communications controller (106) associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In the NOC (102) of FIG. 4, each IP block (104) is enabled to bypass its memory communications controller (106) and send inter-IP block, network-addressed communications (146) directly to the network through the IP block's network interface controller (108). Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through it I/O functions (124) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142) such communications to and from an associated router, and each network interface controller is enabled to both send and receive (146) such communications directly to and from an associated IP block, bypassing an associated memory communications controller (106).

Each network interface controller (108) in the example of FIG. 4 is also enabled to implement virtual channels on the network, characterizing network packets by type. Each network interface controller (108) includes virtual channel implementation logic (138) that classifies each communication instruction by type and records the type of instruction in a field of the network packet format before handing off the instruction in packet form to a router (110) for transmission on the NOC. Examples of communication instruction types include inter-IP block network-address-based messages, request messages, responses to request messages, invalidate messages directed to caches; memory load and store messages; and responses to memory load messages, and so on.

Each router (110) in the example of FIG. 4 includes routing logic (130), virtual channel control logic (132), and virtual channel buffers (134). The routing logic typically is implemented as a network of synchronous and asynchronous logic that implements a data communications protocol stack for data communication in the network formed by the routers (110), links (120), and bus wires among the routers. The routing logic (130) includes the functionality that readers of skill in the art might associate in off-chip networks with routing tables, routing tables in at least some embodiments being considered too slow and cumbersome for use in a NOC. Routing logic implemented as a network of synchronous and asynchronous logic can be configured to make routing decisions as fast as a single clock cycle. The routing logic in this example routes packets by selecting a port for forwarding each packet received in a router. Each packet contains a network address to which the packet is to be routed. Each router in this example includes five ports, four ports (121) connected through bus wires (120-A, 120-B, 120-C, 120-D) to other routers and a fifth port (123) connecting each router to its associated IP block (104) through a network interface controller (108) and a memory communications controller (106).

In describing memory-address-based communications above, each memory address was described as mapped by network interface controllers to a network address, a network location of a memory communications controller. The network location of a memory communication controller (106) is naturally also the network location of that memory communication controller's associated router (110), network interface controller (108), and IP block (104). In inter-IP block, or network-address-based communications, therefore, it is also typical for application-level data processing to view network addresses as location of IP block within the network formed by the routers, links, and bus wires of the NOC. FIG. 3 illustrates that one organization of such a network is a mesh of rows and columns in which each network address can be implemented, for example, as either a unique identifier for each set of associated router, IP block, memory communications controller, and network interface controller of the mesh or x,y coordinates of each such set in the mesh.

In the NOC (102) of FIG. 4, each router (110) implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router (110) in the example of FIG. 4 also includes virtual channel control logic (132) and virtual channel buffers (134). The virtual channel control logic (132) examines each received packet for its assigned communications type and places each packet in an outgoing virtual channel buffer for that communications type for transmission through a port to a neighboring router on the NOC.

Each virtual channel buffer (134) has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer (134) in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller (108). Each network interface controller is configured to, upon receipt of such a signal, refuse to accept, from its associated memory communications controller (106) or from its associated IP block (104), communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 4. When a router encounters a situation in which a packet might be dropped in some unreliable protocol such as, for example, the Internet Protocol, the routers in the example of FIG. 4 suspend by their virtual channel buffers (134) and their virtual channel control logic (132) all transmissions of packets in a virtual channel until buffer space is again available, eliminating any need to drop packets. The NOC of FIG. 4, therefore, implements highly reliable network communications protocols with an extremely thin layer of hardware.

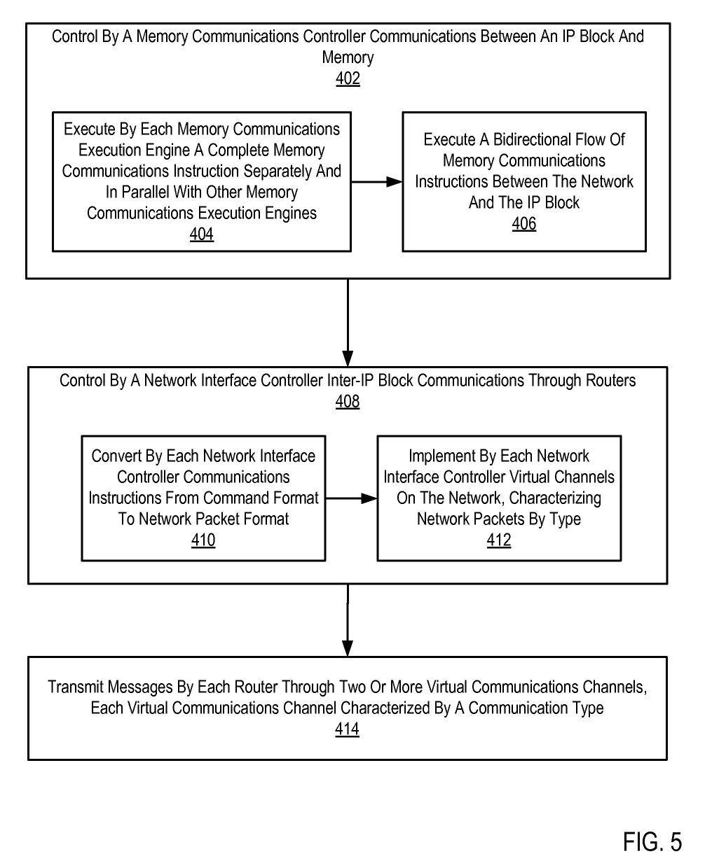

For further explanation, FIG. 5 sets forth a flow chart illustrating an exemplary method for data processing with an apparatus useful for emulating a computer run time environment according to embodiments of the present invention, a NOC. The method of FIG. 5 is implemented on a NOC similar to the ones described above in this specification, a NOC (102 on FIG. 4) that is implemented on a chip (100 on FIG. 4) with IP blocks (104 on FIG. 4), routers (110 on FIG. 4), memory communications controllers (106 on FIG. 4), and network interface controllers (108 on FIG. 4). Each IP block (104 on FIG. 4) is adapted to a router (110 on FIG. 4) through a memory communications controller (106 on FIG. 4) and a network interface controller (108 on FIG. 4). In the method of FIG. 5, each IP block may be implemented as a reusable unit of synchronous or asynchronous logic design used as a building block for data processing within the NOC.

The method of FIG. 5 includes controlling (402) by a memory communications controller (106 on FIG. 4) communications between an IP block and memory. In the method of FIG. 5, the memory communications controller includes a plurality of memory communications execution engines (140 on FIG. 4). Also in the method of FIG. 5, controlling (402) communications between an IP block and memory is carried out by executing (404) by each memory communications execution engine a complete memory communications instruction separately and in parallel with other memory communications execution engines and executing (406) a bidirectional flow of memory communications instructions between the network and the IP block. In the method of FIG. 5, memory communications instructions may include translation lookaside buffer control instructions, cache control instructions, barrier instructions, memory load instructions, and memory store instructions. In the method of FIG. 5, memory may include off-chip main RAM, memory connected directly to an IP block through a memory communications controller, on-chip memory enabled as an IP block, and on-chip caches.

The method of FIG. 5 also includes controlling (408) by a network interface controller (108 on FIG. 4) inter-IP block communications through routers. In the method of FIG. 5, controlling (408) inter-IP block communications also includes converting (410) by each network interface controller communications instructions from command format to network packet format and implementing (412) by each network interface controller virtual channels on the network, including characterizing network packets by type.

The method of FIG. 5 also includes transmitting (414) messages by each router (110 on FIG. 4) through two or more virtual communications channels, where each virtual communications channel is characterized by a communication type. Communication instruction types, and therefore virtual channel types, include, for example: inter-IP block network-address-based messages, request messages, responses to request messages, invalidate messages directed to caches; memory load and store messages; and responses to memory load messages, and so on. In support of virtual channels, each router also includes virtual channel control logic (132 on FIG. 4) and virtual channel buffers (134 on FIG. 4). The virtual channel control logic examines each received packet for its assigned communications type and places each packet in an outgoing virtual channel buffer for that communications type for transmission through a port to a neighboring router on the NOC.

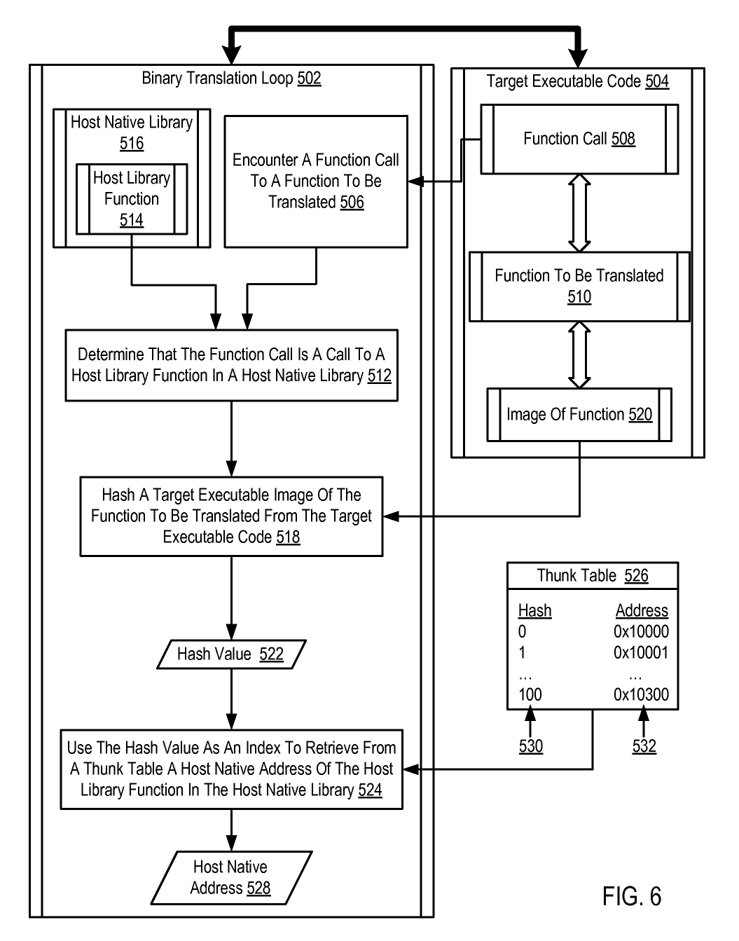

For further explanation, FIG. 6 sets forth a flow chart illustrating an exemplary method for emulating a computer run time environment according to embodiments of the present invention. Emulation as the term is used in this specification refers to the imitation of one computer, the target computer, by another computer, the host computer. The method of FIG. 6 is implemented as a component of a dynamic binary translation loop (502). Binary translation is the emulation of one instruction set by another through translation of code. In binary translation, instructions are translated from a target instruction set to a host instruction set. The term ‘target’ as used in this specification refers to a subject of emulation, while the term ‘host’ refers to a computing environment upon which a target is emulated.

There are two types of binary translation, static and dynamic. In static binary translation, an entire executable file is translated prior to execution of the file into an executable file of the host architecture. In dynamic translation, by contrast, code is translated as it discovered during execution of the code in an emulated computer run time environment. Dynamic translation typically includes translating a short sequence of code such as, for example, a single basic block, and caching the resulting translated sequence for execution in the emulated computer run time environment.

The exemplary dynamic binary translation loop (502) of FIG. 6 is a module of computer program instructions that translates target executable code (504) compiled for execution on a target computer to code executable on a host computer of a kind other than the target computer. The target executable code (504) may include any computer program instructions capable of execution, without translation, on a target computer, such as for example, software applications. The exemplary target executable code (504) in the method of FIG. 6 includes, for example, function calls (508) to functions (510) to be translated. The function calls (508) in the target executable code may be calls to functions in standalone libraries associated with the target executable code, libraries of an emulated target operating system, and so on as will occur to those of skill in the art.

Upon encountering (506) in the binary translation loop (502) a function call (508) to a function (510) to be translated, the method of FIG. 6 continues by determining (512) that the function call (508) is a call to a host library function (514) in a host native library (516). Such a host native library (516) includes a collection of host library functions (514). The exemplary host library function (514) of FIG. 6 is a function, a module of computer program instructions that performs a specific task which is provided by a host computer system to code executable on the host computer. Most modern operating systems, for example, typically provide many libraries of functions that implement system services for a host computer.

The method of FIG. 6 also includes hashing (518) a target executable image (520) of the function (510) to be translated from the target executable code (504), thereby producing a hash value (522). A target executable image (520) of the function (510) to be translated includes code, typically in binary or hexadecimal form, capable of execution on a target computer, where the code represents computer program instructions that carry out the function to be translated. Hashing (518) a target executable image (520) of the function (508) to be translated from the target executable code (504) may be carried out by applying a hashing algorithm to the target executable image of the function. A hashing algorithm is a reproducible method of turning some kind of data into a single value, often a relatively small number that may serve as a digital representation of the data. The hashing algorithm typically substitutes or transposes the data to create such a digital representation. The output of a hashing algorithm is a hash value.

The method of FIG. 6 also includes using (524) the hash value (522) as an index to retrieve from a thunk table (526) a host native address (528) of the host library function (514) in the host native library (516). The term ‘thunk’ typically refers to a process of mapping machine data from one system-specific form to another, usually for compatibility reasons. Running a 16-bit program on a 32-bit operating system, for example, may require a so-called ‘thunk’ from 16-bit addresses to 32-bit addresses.

Thunk in this sense may also refer to mappings from one calling convention to another or from one version of a library to another. A thunk table (526) as used in this specification is a data structure useful for storing associations of data from one computer system-specific form, the target computer form, with data from another computer-system specific form, the host computer form. The exemplary thunk table (526) of FIG. 6 is an example of a data structure that associates target data forms and host data forms as a column (530) of hash values of function calls of target executable code and a column (532) of host native addresses of host library functions of a host computer, so that each record in the exemplary thunk table (526) of FIG. 6 associates a hash value of a function to be translated and a host native address of a corresponding host library function.

The binary translation loop (502), after retrieving the host native address from the thunk table (526), may return the host native address (528) of the host library function (514) to the emulated computer run time environment of the target computer. The emulated computer run time environment may call the host library function (514) at the host native address (528) and administer any return value or values that may be produced by the execution of the host library function (514).

As an alternative to returning, by the binary translation loop (502) to the emulated computer run time environment of the target computer, only the host native address (528) of the host library function (514), the binary translation loop (502) may return to the emulated computer run time environment an entire executable image of the host library function (514). From the perspective of the emulated computer run time environment, such a return of an entire executable image of the host library function (514) would appear no different than an actual translation of the target function (510). The emulated computer run time environment may execute the executable image of the host library function and administer any return value or values that may be produced by the execution of the host library function (514).

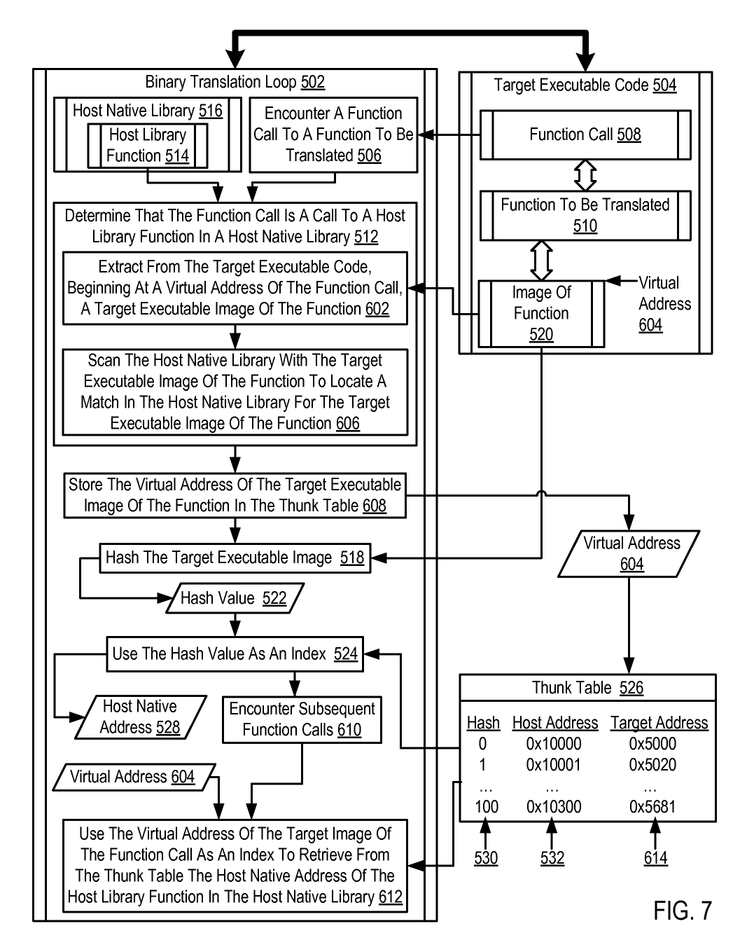

For further explanation, FIG. 7 sets forth a flow chart illustrating a further exemplary method for emulating a computer run time environment according to embodiments of the present invention. The method of FIG. 7 is similar to the method of FIG. 6, including as it does, determining (512), upon encountering (506) in the binary translation loop (502) a function call (508) to a function (510) to be translated, that the function call (508) is a call to a host library function (514) in a host native library (516); hashing (518) a target executable image (520) of the function (508) to be translated from the target executable code (504), thereby producing a hash value (522); and using (524) the hash value (522) as an index to retrieve from a thunk table (526) a host native address (528) of the host library function (514) in the host native library (516).

The method of FIG. 7 differs from the method of FIG. 6, however, in that in the method of FIG. 7, determining (512) that the function call (508) is a call to a host library function (514) in a host native library (516) is carried out by extracting (602) from the target executable code (504), beginning at a virtual address (604) of the function call (508), a target executable image (520) of the function (510) and scanning (606) the host native library (516) with the target executable image (520) of the function (510) to locate a match in the host native library (516) for the target executable image (520) of the function (510). Function calls, by use of such a virtual address (604), identify a location in memory where code to carry out the function exists.

The method of FIG. 7 also includes storing (608) the virtual address (604) of the target executable image (520) of the function (510) in the thunk table (526) in association with the hash value (522) and the host native address (528) of the host library function (514) in the host native library (516). Upon encountering (610) subsequent function calls to the same function (510) to be translated, the method of FIG. 7 continues by using (612) the virtual address (604) of the target image (520) of the function call (508), without hashing (518) the image (520) of the function (510), as an index to retrieve from the thunk table (526) the host native address (528) of the host library function (514) in the host native library (516). In this way, the target executable image (520) of the function need only be hashed, in the exemplary method of FIG. 7, upon the first occurrence of a function call to the function.

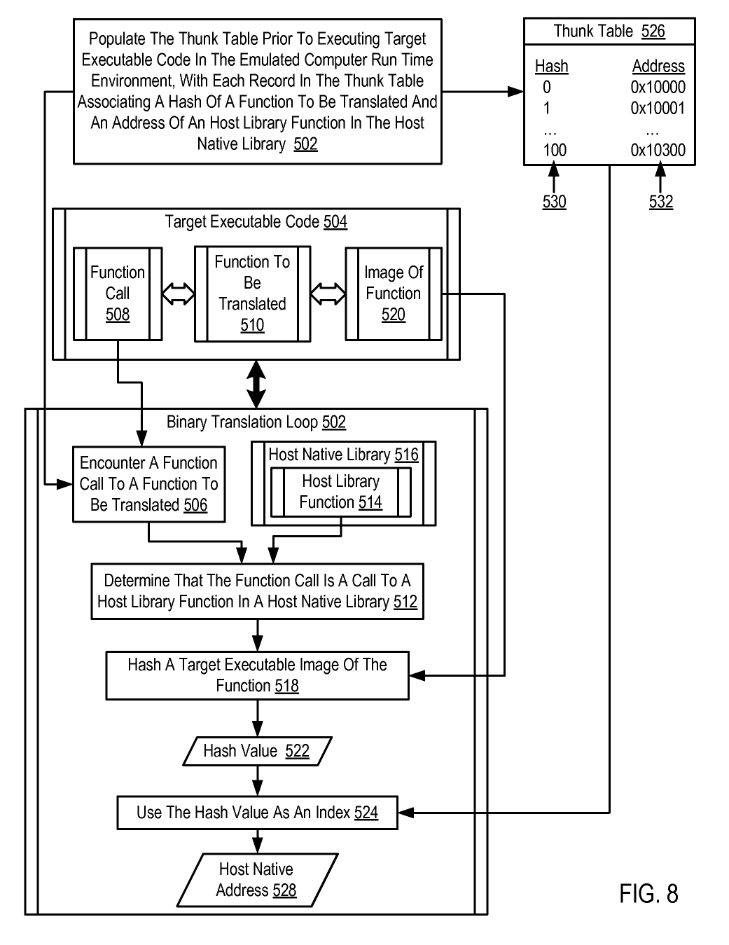

For further explanation, FIG. 8 sets forth a flow chart illustrating a further exemplary method for emulating a computer run time environment according to embodiments of the present invention. The method of FIG. 8 is similar to the method of FIG. 6, including as it does, determining (512), upon encountering (506) in the binary translation loop (502) a function call (508) to a function (510) to be translated, that the function call (508) is a call to a host library function (514) in a host native library (516); hashing (518) a target executable image (520) of the function (508) to be translated from the target executable code (504), thereby producing a hash value (522); and using (524) the hash value (522) as an index to retrieve from a thunk table (526) a host native address (528) of the host library function (514) in the host native library (516).

The method of FIG. 8 differs from the method of FIG. 6, however, in that method of FIG. 8 includes populating (502) the thunk table (526) prior to executing target executable code in the emulated computer run time environment, with each record in the thunk table associating a hash (530) of a function to be translated and an address (532) of a host library function in the host native library.

Functions (510) to be translated in target executable code (504) may be included in static libraries or dynamically linked libraries. In cases where functions (510) to be translated are included in static libraries, the memory address of function calls in the target executable code identify an actual location of functions in the static libraries prior execution of the target code, that is, prior to run time. In cases where functions (510) to be translated are included in dynamically linked libraries, in contrast, the addresses of function calls do not identify an actual location of functions until the target executable code and all dynamically linked libraries are loaded into memory. In the static case, therefore, populating (502) the thunk table (526) prior to executing target executable code in the emulated computer run time environment may be carried out by scanning the target executable code for function calls; locating a target executable image of a function to be translated through use of a memory address of a function call; scanning a host native library for a host library function that matches the function to be translated; hashing a target executable image of the function to be translated; and recording in the thunk table the host native address of the matching host library function and the hash value of the target executable image of the function to be translated.

Exemplary embodiments of the present invention are described largely in the context of a fully functional computer system for emulating a computer run time environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of emulating a computer run time environment, the method implemented as a component of a dynamic binary translation loop that translates target executable code compiled for execution on a target computer to code executable on a host computer of a kind other than the target computer, the target executable code comprising function calls to functions to be translated, the method comprising:
upon encountering in the binary translation loop a function call to a function to be translated, determining that the function call is a call to a host library function in a host native library;
hashing a target executable image of the function to be translated from the target executable code, thereby producing a hash value; and
using the hash value as an index to retrieve from a thunk table a host native address of the host library function in the host native library.

2. The method of claim 1 wherein determining that the function call is a call to a host library function in a host native library further comprises:
extracting from the target executable code, beginning at a virtual address of the function call, a target executable image of the function; and
scanning the host native library with the target executable image of the function to locate a match in the host native library for the target executable image of the function.

3. The method of claim 2 further comprising:
storing the virtual address of the target executable image of the function in the thunk table in association with the hash value and the host native address of the host library function in the host native library; and
upon encountering subsequent function calls to the same function to be translated, using the virtual address of the target image of the function call, without hashing the image of the function, as an index to retrieve from the thunk table the host native address of the host library function in the host native library.

4. The method of claim 1 further comprising:
populating the thunk table prior to executing target executable code in the emulated computer run time environment, with each record in the thunk table associating a hash of a function to be translated and an address of a host library function in the host native library.

5. The method of claim 1 wherein the method is implemented on a network on chip (‘NOC’), the NOC comprising integrated processor (‘IP’) blocks, routers, memory communications controllers, and network interface controller, each IP block adapted to a router through a memory communications controller and a network interface controller, each memory communications controller controlling communication between an IP block and memory, and each network interface controller controlling inter-IP block communications through routers.

6. The method of claim 5 wherein each IP block comprises a reusable unit of synchronous or asynchronous logic design used as a building block for data processing within the NOC.

7. An apparatus for emulating a computer run time environment, the apparatus comprising a computer processor, a computer memory operatively coupled to the computer processor, the computer memory having disposed within it computer program instructions implemented as a component of a dynamic binary translation loop that translates target executable code compiled for execution on a target computer to code executable on a host computer of a kind other than the target computer, the target executable code comprising function calls to functions to be translated, the computer program instructions capable of:
upon encountering in the binary translation loop a function call to a function to be translated, determining that the function call is a call to a host library function in a host native library;
hashing a target executable image of the function to be translated from the target executable code, thereby producing a hash value; and
using the hash value as an index to retrieve from a thunk table a host native address of the host library function in the host native library.

8. The apparatus of claim 9 wherein determining that the function call is a call to a host library function in a host native library further comprises:
extracting from the target executable code, beginning at a virtual address of the function call, a target executable image of the function; and
scanning the host native library with the target executable image of the function to locate a match in the host native library for the target executable image of the function.

9. The apparatus of claim 8 further comprising computer program instructions capable of:
storing the virtual address of the target executable image of the function in the thunk table in association with the hash value and the host native address of the host library function in the host native library; and
upon encountering subsequent function calls to the same function to be translated, using the virtual address of the target image of the function call, without hashing the image of the function, as an index to retrieve from the thunk table the host native address of the host library function in the host native library.

10. The apparatus of claim 7 further comprising computer program instructions capable of:
populating the thunk table prior to executing target executable code in the emulated computer run time environment, with each record in the thunk table associating a hash of a function to be translated and an address of a host library function in the host native library.

11. The apparatus of claim 7 wherein the apparatus is implemented on a network on chip (‘NOC’), the NOC comprising integrated processor (‘IP’) blocks, routers, memory communications controllers, and network interface controller, each IP block adapted to a router through a memory communications controller and a network interface controller, each memory communications controller controlling communication between an IP block and memory, and each network interface controller controlling inter-IP block communications through routers.

12. The apparatus of claim 11 wherein each IP block comprises a reusable unit of synchronous or asynchronous logic design used as a building block for data processing within the NOC.

13. A computer program product for emulating a computer run time environment, the computer program product disposed in a computer readable, signal bearing medium, the computer program product comprising computer program instructions implemented as a component of a dynamic binary translation loop that translates target executable code compiled for execution on a target computer to code executable on a host computer of a kind other than the target computer, the target executable code comprising function calls to functions to be translated, the computer program instructions capable of:
upon encountering in the binary translation loop a function call to a function to be translated, determining that the function call is a call to a host library function in a host native library;
hashing a target executable image of the function to be translated from the target executable code, thereby producing a hash value; and
using the hash value as an index to retrieve from a thunk table a host native address of the host library function in the host native library.

14. The computer program product of claim 13 wherein determining that the function call is a call to a host library function in a host native library further comprises:
extracting from the target executable code, beginning at a virtual address of the function call, a target executable image of the function; and
scanning the host native library with the target executable image of the function to locate a match in the host native library for the target executable image of the function.

15. The computer program product of claim 14 further comprising computer program instructions capable of:
storing the virtual address of the target executable image of the function in the thunk table in association with the hash value and the host native address of the host library function in the host native library; and
upon encountering subsequent function calls to the same function to be translated, using the virtual address of the target image of the function call, without hashing the image of the function, as an index to retrieve from the thunk table the host native address of the host library function in the host native library.

16. The computer program product of claim 14 further comprising computer program instructions capable of:
populating the thunk table prior to executing target executable code in the emulated computer run time environment, with each record in the thunk table associating a hash of a function to be translated and an address of a host library function in the host native library.

17. The computer program product of claim 14 wherein the computer program instructions are capable of execution upon a network on chip (‘NOC’), the NOC comprising integrated processor (‘IP’) blocks, routers, memory communications controllers, and network interface controller, each IP block adapted to a router through a memory communications controller and a network interface controller, each memory communications controller controlling communication between an IP block and memory, and each network interface controller controlling inter-IP block communications through routers.

18. The computer program product of claim 17 wherein each IP block comprises a reusable unit of synchronous or asynchronous logic design used as a building block for data processing within the NOC.

19. The computer program product of claim 13 wherein the signal bearing medium comprises a recordable medium.

20. The computer program product of claim 13 wherein the signal bearing medium comprises a transmission medium.
